(19) United States
(12) Patent Application Publication
(10) Pub. No.: US 2013/0093303 A1
(43) Pub. Date: Apr. 18, 2013

(54) HOUSEHOLD APPLIANCE INCLUDING A POSITIVE RACK STOP FOR A LOWER RACK SYSTEM

(71) Applicants: Casey Carr, New Bern, NC (US); Mike Holmes, Bethel, NC (US); Jeff Vogus, New Bern, NC (US)

(72) Inventors: Casey Carr, New Bern, NC (US); Mike Holmes, Bethel, NC (US); Jeff Vogus, New Bern, NC (US)

(73) Assignee: BSH HOME APPLIANCES CORPORATION, Huntington Beach, CA (US)

(21) Appl. No.: 13/272,249

(22) Filed: Oct. 13, 2011

(51) Int. Cl. A47L 15/50; B23P 11/00; A47B 81/00

(52) U.S. Cl. 312/228.1; 29/505

(57) ABSTRACT

A household appliance including a lower rack system, the lower rack system including a lower rack movable into and out of the household appliance along first and second tracks extending from a tub of the household appliance to an interior portion of a door of the household appliance. In an exemplary embodiment, the lower rack includes a rack stop structured to limit ingress and egress of the lower rack from the tub along the first and second tracks.

### BACKGROUND OF THE INVENTION

1. Field of the Invention

The present invention relates to a household appliance and more particularly, to a household appliance including a positive rack stop for a lower rack system.

2. Related Art

In the related art, the lower rack system of a household appliance, such as a dishwasher has a lower rack that rolls forward and in return on tracks to allow for the loading and removal of dishware. However, there exists a possibility that the lower rack, when forced to roll further than needed, can roll out of the tracks.

The present invention provides a rack stop that may create a positive stopping feature to prevent the lower rack from rolling too far forward on an interior portion of the door of the household appliance and to prevent the lower rack from falling off the tracks of the interior portion of the door.

### SUMMARY OF THE INVENTION

A first aspect of the present invention is directed to a household appliance. The household appliance may include a lower rack system, the lower rack system having a lower rack movable into and out of the household appliance along first and second tracks extending from a tub of the household appliance to an interior portion of a door of the household appliance. In the first aspect, the lower rack may include a rack stop structured to limit ingress and egress of the lower rack from the tub along the first and second tracks.

A second aspect of the present invention is directed to a method of manufacturing the household appliance. In the second aspect, the method may include the steps of extending one or more wires of a lower rack of the household appliance beyond at least one side of the lower rack; and bending the one or more wires to extend below the lower rack.

The illustrative aspects of the present invention are designed to solve the problems herein described and other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various exemplary embodiments of the disclosure, in which:

FIG. 1 depicts a household appliance including a lower rack system according to an exemplary embodiment of the invention;

FIG. 2. depicts a rack stop according to an exemplary embodiment of the invention; and

FIG. 3 depicts a method for manufacturing a household appliance according to an exemplary embodiment of the invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

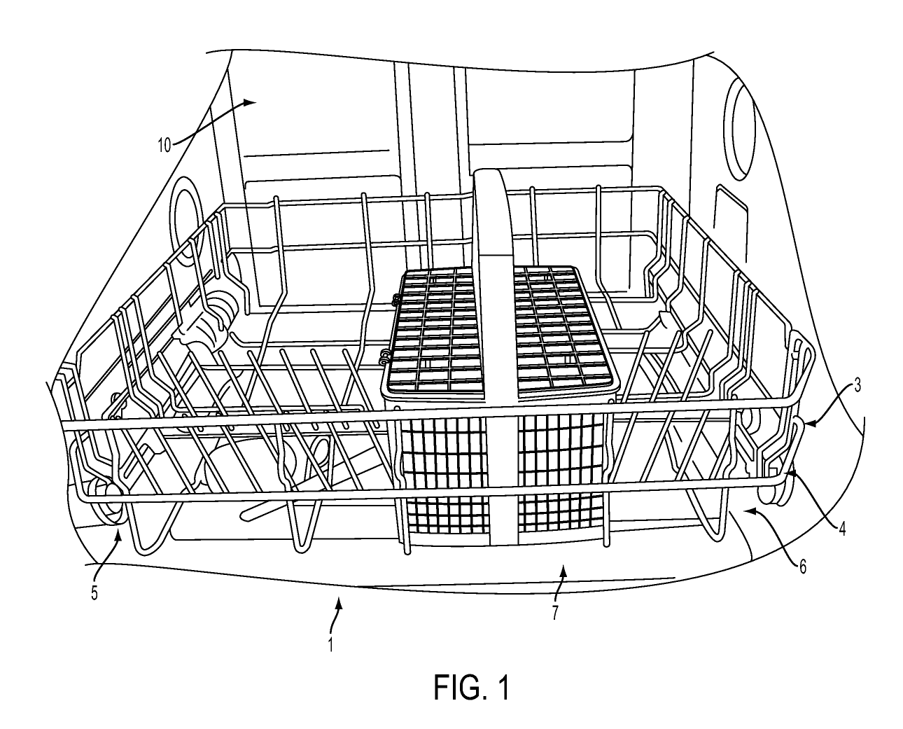

FIG. 1 shows an exemplary embodiment of a household appliance of the present invention, such as a dishwasher 10. The dishwasher 10 may comprise a door 1 which is suitable for tiltable opening.

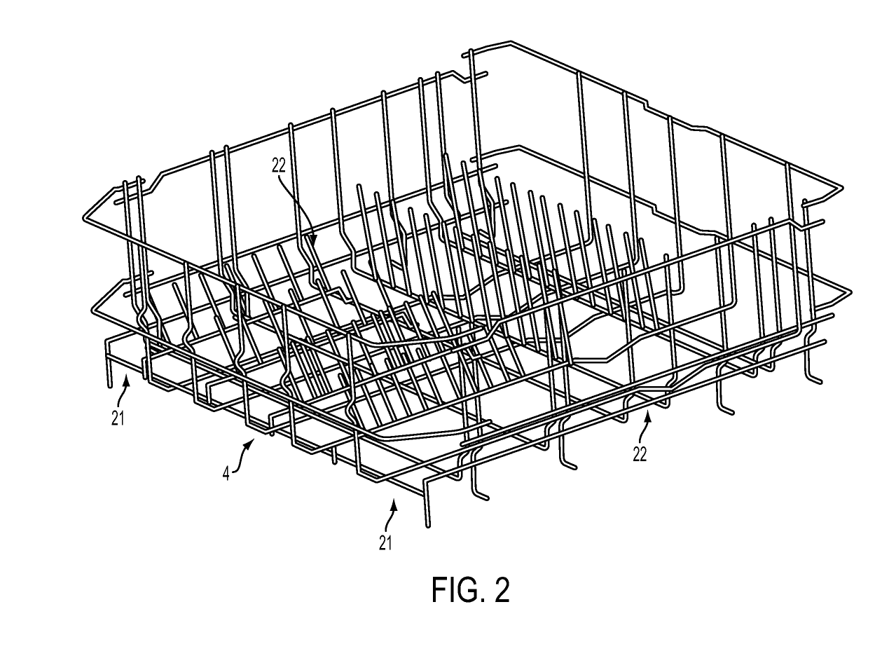

The dishwasher 10 may further include a lower rack system 3 including a lower rack 4 movable into and out of the household appliance along first 5 and second tracks 6 extending from a tub 7 of the dishwasher to an interior portion of the door 1. As shown in FIG. 2, the lower rack system 3 may include a rack stop 21 structured to limit ingress and egress of the lower rack 4 from the tub 7 along the first 5 and second 6 tracks.

The rack stop 21 may be structured to limit the lower rack 4 from rolling too far forward on the interior portion of the door 1 along the first 5 and second 6 tracks. Also, the rack stop 21 may be structured to prevent the lower rack 4 from falling off the interior portion of the door 1.

As further shown in FIG. 2, the rack stop 21 may include one or more wires 22 of the lower rack 4 disposed on at least one side of the lower rack 4. The one or more wires 22 may be structured to extend beyond at least one side of the lower rack 4 and may also extend below the lower rack 4.

In an exemplary embodiment, the one or more wires 22 may include a bend at about a 90° angle from horizontal to extend below the lower rack 4, although other bending possibilities may be envisioned by those of ordinary skill in the art.

In another exemplary embodiment, two of the one or more wires 22 are disposed on opposing sides of the lower rack 4 and extend beyond at least one side of the lower rack 4 and below the lower rack 4.

The one or more wires may be formed from a material consistent with a lower rack of the dishwasher and may be accordingly nylon or vinyl coated.

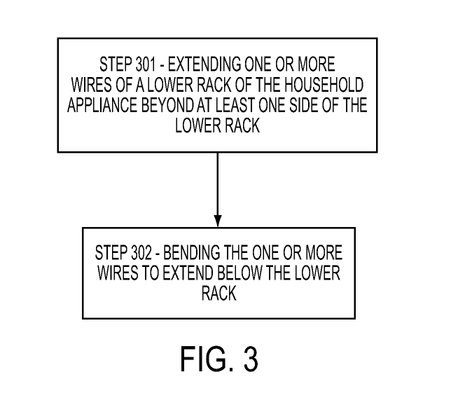

An exemplary method of the invention is depicted in FIG. 3. In a first step 301, the method includes extending one or more wires of a lower rack of the household appliance beyond at least one side of the lower rack. In Step 302, the one or more wires are bent to extend below the lower rack.

As noted above, the one or more wires may be bent at about a 90° angle to extend below the wire rack.

While the one or more wires may be wires formed during manufacturing of the lower rack, the one or more wires may also be attached to the lower rack after assembly of the lower rack. This will facilitate adding a rack stop to existing dishwasher lower racks.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A household, comprising:
a lower rack system, the lower rack system including a lower rack movable into and out of the household appliance along first and second tracks extending from a tub of the household appliance to an interior portion of a door of the household appliance, and wherein the lower rack includes a rack stop structured to limit ingress and egress of the lower rack from the tub along the first and second tracks.

2. The household appliance according to claim 1, wherein the rack stop is structured to limit the lower rack from rolling too far forward on the interior portion of the door along the first and second tracks.

3. The household appliance according to claim 1, wherein the rack stop is structured to prevent the lower rack from falling off the interior portion of the door.

4. The household appliance according to claim 1, wherein the rack stop includes one or more wires of the lower rack disposed on at least one side of the lower rack.

5. The household appliance according to claim 4, wherein the one or more wires are structured to extend beyond at least one side of the lower rack.

6. The household appliance according to claim 4, wherein the one or more wires are structured to extend below the lower rack.

7. The household appliance according to claim 6, wherein the one or more wires include a bend at about a 90° angle from horizontal to extend below the lower rack.

8. The household appliance according to claim 1, wherein two of the one or more wires are disposed on opposing sides of the lower rack.

9. The household appliance according to claim 8, wherein the two wires are structured to extend beyond at least one side of the lower rack.

10. The household appliance according to claim 8, wherein the two wires are structured to extend below the lower rack.

11. The household appliance according to claim 10, wherein the two wires include a bend at about a 90° angle from horizontal to extend below the lower rack.

12. The household appliance according to claim 4, wherein the one or more wires are one of nylon and vinyl coated.

13. The household appliance according to claim 1, wherein the household appliance is a dishwasher and wherein the lower rack is structured to hold dishes of the dishwasher.

14. A method of manufacturing a household appliance comprising the steps of:
extending one or more wires of a lower rack of the household appliance beyond at least one side of the lower rack; and
bending the one or more wires to extend below the lower rack.

15. The method of claim 14, wherein the one or more wires are bent at about a 90° angle to extend below the wire rack.

16. The method of claim 14, wherein the one or more wires are bent on both sides of the wire.

17. The method of claim 14, wherein the one or more wires are attached to the lower rack after assembly of the lower rack.

18. The method of claim 14, wherein the one or more wires are disposed on opposing sides of the lower rack.
